(19) United States
(12) Patent Application Publication
(10) Pub. No.: US 2025/0259167 A1
(43) Pub. Date: Aug. 14, 2025

(54) Federated Strategy Implementation to Improve the Transaction Per Second (TPS) in Proof of Work and Proof of Stake with Carbon Efficiency

(71) Applicant: Bank of America Corporation, Charlottee, NC (US)

(72) Inventors: Gowri Sundar Suriyanarayanan, Chennai (IN); Maneesh Kumar Sethia, Hyderabad (IN); Sivashalini Sivajothi, Chennai (IN); Parameswari K, Chennai (IN); Ashokkumar M, Chennai (IN); Shameera Roohin Mohammed Nasrullah, Chengalpattu (IN)

(21) Appl. No.: 18/436,838

(22) Filed: Feb. 8, 2024

(51) Int. Cl. G06Q 20/38; G06Q 20/40; G06Q 30/018

(52) U.S. Cl. CPC G06Q 20/389; G06Q 20/401; G06Q 30/018

(57) ABSTRACT

Federated Learning systems and methods optimize blockchain transaction processing speed (TPS) and carbon efficiency. Blockchain networks have nodes with a Local Federated Learning Model (LFLM) that can develop/refine computational strategies for block generation in PoW systems or transaction validation in POS systems without revealing sensitive data. Nodes communicate with a Federated Learning Information Server (FLIS) to aggregate, analyze, and distribute optimized strategies across the network to reduce block generation and transaction validation computational resources. This boosts TPS and cuts blockchain network energy use. Incentive-mechanisms reward nodes that create/share efficient computational strategies, encouraging innovation. Dynamic strategy adoption modules select and apply optimum strategies based on network conditions and node capabilities. The POS system auto-approves validators to ensure transaction validation. Decentralized computational strategy exchange via a peer-to-peer protocol is also disclosed. Federated Learning with blockchain technology improves operational efficiency and reduces energy consumption and carbon footprint.

### TECHNICAL FIELD

The present disclosure relates to Data Processing: Artificial Intelligence (AI) and, more particularly, to methods and apparatus involving AI techniques, such as machine learning, as applied to blockchain networks, specifically focusing on optimizing computational strategies through Federated Learning, which is a machine learning approach that enables the training of an algorithm across multiple decentralized devices or servers holding local data samples, without exchanging them.

### DESCRIPTION OF THE RELATED ART

Blockchain networks serve as decentralized digital ledgers that ensure the integrity and security of data by recording transactions across multiple computers. Each block in the chain contains several transactions, and with each new transaction on the blockchain, a record is added to every participant's ledger. This decentralized nature prevents tampering and ensures transparency, thereby making blockchain a foundational technology for cryptocurrencies, documentation, and a variety of applications across numerous industries. The mechanisms behind crypto transactions primarily operate on two methodologies: Proof of Work (PoW) and Proof of Stake (PoS). PoW, associated with Bitcoin, involves miners solving complex problems to create blocks and validate transactions. Conversely, PoS, which Ethereum has adopted, selects block creators based on their stake in the network, eliminating the need for solving computational puzzles. This distinction significantly impacts resource consumption, with POW requiring substantial computational power and energy, leading to environmental concerns and scalability issues due to the slow transaction speeds and increased costs.

In PoW systems, the mining process, which involves solving cryptographic challenges, is time-intensive and energy-consuming. Only the first miner to solve the puzzle receives the reward, fostering a competitive environment that often leads to a backlog of transactions. POS systems, on the other hand, choose validators for transaction validation based on their stake, aiming to be more energy efficient. However, they face challenges related to network security and the potential concentration of control among larger stakeholders. Validators, incentivized by processing revenues, might prioritize larger transactions, potentially delaying smaller ones. Moreover, real-world constraints like network connectivity and hardware limitations can hinder the validation process, affecting the network's overall efficiency.

Both PoW and PoS blockchain networks exhibit key inefficiencies, such as high energy consumption, variable transaction speeds, centralization risks, and potential bias by validators towards larger transactions. These challenges highlight the need for a Federated Learning solution to improve the efficiency and sustainability of blockchain networks. Such a solution could reduce energy consumption, accelerate transaction speeds, enhance decentralization, and ensure fairer transaction processing, thereby addressing environmental sustainability and the broader principle of net neutrality within the blockchain domain. Achieving net neutrality in this context shifts from its traditional definition towards optimizing blockchain operations for carbon efficiency, aiming to reduce the environmental impact of blockchain transactions by utilizing resources more efficiently. This approach not only meets the technical and security requirements for block creation and transaction processing but also aligns with environmental goals, promoting sustainability in the rapidly growing field of cryptocurrency and blockchain technology.

### SUMMARY OF THE INVENTION

In the disclosed solutions, advanced systems and methods are proposed to enhance the efficiency and sustainability of blockchain networks. These solutions leverage a Federated Learning model, allowing nodes in both Proof of Work (PoW) and Proof of Stake (POS) systems to collaboratively develop and share optimal computational strategies for generating blocks and validating transactions. This collaborative effort is facilitated by a central Federated Learning server, which distributes these strategies to improve overall network performance. Features of this approach include a local Federated Learning model to ensure privacy, an information server dedicated to optimizing strategies, an auto-approval mechanism for validators who are temporarily unavailable, and an incentive system that rewards the development and implementation of resource-efficient strategies. The goal is to minimize resource consumption, accelerate transaction processing, and uphold data privacy and security.

Further, a sustainable blockchain technology approach is outlined, emphasizing the reduction of resource consumption in environmental terms. It introduces an incentive system designed to reward individuals who devise more resource-efficient block creation methods, which could lead to significant reductions in energy use, as well as lower the time and computational power needed for transaction processing. This focus on efficiency seeks to make blockchain technology more sustainable by encouraging innovations that lessen its environmental impact.

When someone devises a new, more efficient strategy, this innovation is shared with all participants in the network. If a person finds a better solution that supersedes existing methods, this new approach is adopted by the network, leading to a collective improvement in efficiency. This system ensures continuous innovation and optimization in the blockchain process, contributing to environmental sustainability by reducing the overall resource footprint.

This model promotes a form of competition and collaboration that benefits the entire network. It aligns individual incentives with collective environmental goals, encouraging the development and adoption of strategies that reduce energy consumption and carbon emissions. This approach supports the broader goal of achieving net neutrality in environmental impact, ensuring the blockchain runs more sustainably.

To overcome key inefficiencies in both POW and PoS blockchain networks, including high energy consumption, variable transaction speeds, centralization risks, and validator bias, a Federated Learning approach can be used. The system can include:
a. Local Federated Learning Model (LFLM): Each node independently develops and trains its own computational strategy for block generation or transaction validation within its LFLM. It analyzes and improves the node's computational strategy for block creation (PoW) or transaction validation (POS) accessing no sensitive data. The LFLM protects sensitive data and only shares anonymized strategies with the Federated Learning information server (FLIS). This model only extracts and shares anonymized performance metrics and strategy parameters relevant to improving efficiency. The LFLM constantly trains and refines the strategy based on past performance and network conditions, adapting to optimize resource usage, to provide continuous learning.
b. Federated Learning Information Server (FLIS): It collects anonymized strategy data from all participating nodes' LFLMs. The FLIS aggregates and analyzes the data, identifying patterns and trends to find the most efficient strategies. The FLIS publishes the optimized strategies back to the network for nodes to access and use. By analyzing data from many nodes, the FLIS can identify solutions that individual nodes might miss, leading to better overall network performance. Nodes keep autonomy while benefitting from insights gleaned from the entire network, hence it is decentralized yet optimized.
c. Publish Computational Strategy: Once the FLIS identifies ideal strategies, it publishes them back to the network, accessible to all nodes, to share the knowledge. Nodes can download and adopt suitable strategies based on their hardware, network conditions, and preferences, to empower individual choice. As conditions change or new strategies emerge, the FLIS continuously updates the available options, letting nodes adapt and maintain efficiency, to provide dynamic adaptation.
d. Strategy Sharing, Adoption, and Auto-Approval: For PoW, optimized strategies for block generation help reduce computational resources needed, potentially reducing energy consumption, and accelerating block creation. For POS, validators leverage published strategies for faster transaction validation, improving network throughput. If a validator is unavailable, an auto-approval mechanism selects and uses a suitable strategy to ensure continuous operation. This backup mechanism ensures continuous operation even if a validator is unavailable. The auto-approval system intelligently chooses a suitable strategy from options, considering factors like transaction priority and network load. And it guarantees uninterrupted validation and transaction processing, enhancing network reliability.
e. Incentivization and Sustainability: Nodes contributing efficient strategies earn rewards or are compensated when others adopt them, motivating continuous improvement and collaboration. The system favors strategies that use less computation, encouraging energy-efficient block creation and validation, making the network greener, to reward sustainability. Stated differently, the system rewards strategies that use less computation, promoting sustainable blockchain operation to provide carbon efficiency.

Considering the foregoing, the following presents a simplified summary of the present disclosure to provide a basic understanding of various aspects of the disclosure. This summary is not limiting regarding the exemplary parts of the inventions described and is not an extensive overview of the disclosure. It is not intended to identify key or critical elements of or steps in the disclosure or to delineate the scope of the disclosure. Instead, as understood by a personal of ordinary skill in the art, the following summary merely presents concepts of the disclosure in a simplified form as a prelude to the more detailed description below. Sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a system is designed to enhance transaction processing speed and carbon efficiency in blockchain networks using Federated Learning. It consists of multiple nodes, each equipped with a Local Federated Learning Model. These models are tasked with creating and refining computational strategies for block generation in PoW systems or transaction validation in POS systems, while keeping sensitive data confidential.

A Federated Learning Information Server is linked to these nodes, aggregating, analyzing, and broadcasting optimized strategies across the blockchain network. The goal is to decrease the resources needed for block generation and transaction validation, which boosts transaction processing speed and reduces the energy consumption associated with blockchain network operations.

There is an incentive mechanism in place to reward nodes that devise and circulate efficient computational strategies that other nodes adopt. The reward is contingent on these strategies by others, fostering an environment of continuous innovation and optimization of computational strategies within the blockchain network.

Each node has a dynamic strategy adoption module that autonomously selects and applies the most efficient strategy. This choice is based on the current network conditions, the capabilities of the node's hardware, and set criteria aimed at optimizing block generation and transaction validation processes.

For validators in the POS system, there's an auto-approval mechanism. This system is engineered to automatically validate transactions using the best strategy from the options from the FLIS, even when a validator is not present, thus ensuring continuous transaction validation within the blockchain network.

Finally, the system includes a strategy sharing protocol. This protocol encourages a decentralized exchange of computational strategies directly between nodes in a peer-to-peer way. It allows the blockchain network to move from a centralized Federated Learning model to a decentralized, unsupervised learning model, thus enhancing the network's resilience, scalability, and ability to adapt to network condition changes. In some arrangements, the Local Federated Learning Model comes with a privacy-preserving feature. This feature makes sure that sensitive transaction data stays within the node. Only anonymized performance metrics and strategy parameters are relayed to the Federated Learning Information Server for strategy optimization. Additionally, there is a continuous learning module within the LFLM. This module is designed to adaptively refine the node's computational strategy based on the feedback from the FLIS regarding the performance of strategies shared across the blockchain network.

In some arrangements, the Federated Learning Information Server uses machine learning algorithms. These algorithms are used to detect patterns in the strategy data aggregated from nodes, which helps in pinpointing universally efficient strategies. These strategies significantly enhance transaction processing speed and carbon efficiency across the blockchain network.

In some arrangements, the incentive mechanism includes a gas compensation model. This model dispenses rewards as cryptocurrency or transaction amount discounts, carbon credits, or other incentives to nodes. These rewards are for strategies that lead to measurable improvements in network performance and environmental sustainability.

In some arrangements, the dynamic strategy adoption module is structured to regularly review and update the chosen computational strategy. This is based on real-time analysis of network performance data and newly identified computational strategies by the FLIS. The goal is to make sure each node consistently runs using the most effective and resource-efficient strategy available.

In some arrangements, the system features an optimization feedback loop within the dynamic strategy adoption module. This loop is set up to automatically report the performance outcomes of the adopted computational strategies back to the LFLM. The loop enhances the precision of future strategy selections by incorporating real-world performance data into the LFLM's strategy refinement process.

In some arrangements, the auto-approval mechanism for validators is augmented by a priority transaction identification feature. This feature is configured to recognize high-priority transactions based on predefined criteria and ensure their expedited validation. It does this by applying the most efficient computational strategy available, thus optimizing the blockchain network's responsiveness to time-sensitive transactions.

In some arrangements, the strategy sharing protocol includes a cryptographic strategy validation mechanism. This mechanism is tasked with authenticating the origin and integrity of shared computational strategies. It makes sure only verified and secure strategies are distributed and adopted across the blockchain network. This maintains the network's security posture while helping with decentralized learning.

In some arrangements, the system incorporates a network condition monitoring module within the FLIS. This module is tasked with continually assessing the current state of the blockchain network. It looks at factors like transaction volume, block generation time, and overall network congestion. It then dynamically adjusts the dissemination of computational strategies to prioritize those most effective under the prevailing network conditions.

In some arrangements, the incentive mechanism is designed to implement a tiered reward structure. This structure variably compensates nodes based on the impact level of their contributed computational strategies on the blockchain network's efficiency and carbon footprint. It incentivizes the development and sharing of groundbreaking strategies that offer the highest benefits in terms of transaction processing speed improvement and energy consumption reduction.

In some arrangements, a method for enhancing transaction processing speed and carbon efficiency in blockchain networks through Federated Learning involves several steps. This method starts by setting up multiple nodes within a blockchain network. Each of these nodes has its own Local Federated Learning Model. These models can create and improving computational strategies for generating blocks in PoW systems or validating transactions in POS systems. During this process, sensitive transaction data is not revealed.

The method includes the use of a Federated Learning Information Server. This server is linked to the network of nodes and takes on the role of collecting, analyzing, and sending out optimized computational strategies across the blockchain network. The goal is to lower the amount of computational resources needed for generating blocks and validating transactions, which should improve transaction processing speeds and reduce the energy consumption of the network's operations.

To encourage ongoing innovation and the optimization of computational strategies across the blockchain network, an incentive mechanism is in place. This mechanism rewards the nodes that create and share efficient strategies, especially when these strategies are adopted by others within the network. The rewards are based on how often the shared strategies are used by others.

Each node has a dynamic strategy adoption module. This module is tasked with automatically choosing and implementing the most effective computational strategy from the Federated Learning Information Server. The choice is based on the current conditions of the network, the capabilities of the node's hardware, and a set of criteria predetermined to optimize block generation and transaction validation processes.

An auto-approval mechanism is activated for validators in POS systems. This mechanism automatically approves transactions using the best strategy available from the ones published by the Federated Learning Information Server. This is important when a validator is not available, making sure the validation of transactions continues without interruption.

The method also streamlines the decentralized transfer of computational strategies between nodes. This is achieved through a strategy sharing protocol that operates on a peer-to-peer basis. It allows the blockchain network to move from a centralized Federated Learning model to a decentralized, unsupervised model. This transition improves the network's resilience, scalability, and ability to adapt to changes in network conditions.

Within the Local Federated Learning Model, a privacy-preserving feature is incorporated. This feature makes sure sensitive transaction data stays within the node. Only anonymized performance metrics and strategy parameters are shared with the Federated Learning Information Server for strategy optimization.

The nodes' Local Federated Learning Model also includes a continuous learning module. This module is set up to continuously refine the node's computational strategy. It does so by using feedback from the Federated Learning Information Server, which monitors the performance of the strategies shared across the blockchain network.

Machine learning algorithms within the Federated Learning Information Server are employed to detect patterns in the strategy data collected from the nodes. This enables the server to pinpoint universally efficient strategies that could lead to significant improvements in transaction processing speed and carbon efficiency throughout the blockchain network.

The incentive mechanism includes a gas compensation model. This model provides rewards as cryptocurrency or transaction amount discounts to nodes that offer strategies leading to real improvements in the network's performance and environmental sustainability.

The dynamic strategy adoption module within each node is programmed to routinely assess and update the computational strategy in use. It bases its updates on a real-time analysis of network performance data and newly identified computational strategies from the Federated Learning Information Server. This makes sure each node is consistently operating with the most effective and resource-efficient strategy.

In some arrangements, more steps may be performed such as analyzing the real-time performance outcomes of the strategies in use at each node. An optimization feedback loop within the dynamic strategy adoption module reports these outcomes to the Local Federated Learning Model. This feedback loop aims to refine future strategy selection by integrating actual performance data into the strategy improvement process.

In some arrangements, the auto-approval mechanism for validators is improved with a feature that identifies high-priority transactions. This feature is designed to expedite the validation of such transactions by applying the most effective computational strategy available. This optimizes the blockchain network's response to transactions that are time sensitive.

In some arrangements, the method includes using a cryptographic strategy validation mechanism within the strategy sharing protocol. This mechanism authenticates the origin and integrity of the computational strategies that are shared. It makes sure only strategies that have been verified and are secure are spread and adopted across the blockchain network. This step is important in maintaining the security of the network while enabling decentralized learning.

In some arrangements, a continuous assessment of the blockchain network's current state is carried out. This includes monitoring the volume of transactions, the time it takes to generate blocks, and overall network congestion. This task is managed by a network condition monitoring module within the Federated Learning Information Server. The module dynamically adjusts the distribution of computational strategies to favor those that are most effective under existing network conditions.

In some arrangements, the method includes implementing a tiered reward structure within the incentive mechanism. This reward structure is designed to provide variable compensation to nodes. The level of compensation is based on the impact of the nodes' contributed computational strategies on the efficiency and carbon footprint of the blockchain network. This approach incentivizes the development and sharing of innovative strategies that significantly improve transaction processing speed and reduce energy consumption.

In some arrangements, the method includes establishing a decentralized strategy update mechanism. This mechanism lets nodes directly exchange updates on computational strategies without relying on the Federated Learning Information Server (FLIS). It enhances the network's ability to rapidly adapt to changes and innovations in computational strategies. This feature further decentralizes the learning process, promoting agility and collaborative evolution within the network.

In some arrangements, the method incorporates integrating an adaptive learning rate change feature within the Local Federated Learning Model (LFLM). This feature is configured to change the learning rate based on the complexity of the computational strategy and the node's performance history. By doing so, it optimizes the speed and effectiveness of the strategy refinement and adoption processes, making sure the strategies remain effective and responsive to the network's needs.

In some arrangements, the method involves deploying a collaborative anomaly detection module across the network. Nodes work together to identify and mitigate potential security threats or inefficiencies in computational strategies. By leveraging the collective intelligence of the blockchain network, this module enhances the security and efficiency of the network through Federated Learning. This collaborative approach makes sure the network remains strong against an array of potential vulnerabilities.

In some arrangements, a blockchain network optimization system includes a network of blockchain nodes. Each node in this network is configured with a local learning module. These modules are tasked with independently developing computational strategies aimed at optimizing block generation and transaction validation processes.

The system also features a centralized analysis and distribution server. This server's role is to aggregate the computational strategies that have been developed by the nodes. It analyzes these strategies to determine their effectiveness in terms of transaction processing speed and resource efficiency. Once the analysis is complete, the server distributes the optimized strategies back to the network.

There is an incentive mechanism within the system. It is designed to reward nodes for the creation and sharing of strategies. The rewards are given when these strategies lead to measurable improvements in network performance and environmental sustainability. The reward amount can be based on the rate of adoption and the effectiveness of the shared strategies.

Each node has a dynamic adaptation mechanism. This mechanism is responsible for automatically selecting and implementing the most efficient computational strategy available. The choice is based on real-time network conditions, the hardware capabilities of the node, and environmental impact considerations.

For systems using a PoS consensus model, the system includes an automated validation mechanism. This mechanism enables the automatic approval of transactions absent validators. It runs based on preselected ideal strategies to make sure the network's operation continues uninterrupted.

The system also boasts a strategy sharing framework. This optional framework allows for the direct, peer-to-peer exchange of computational strategies among nodes. It helps with a decentralized and collaborative approach to continuous network optimization.

The system is founded on Federated Learning principles. These principles enable the harnessing of collective intelligence in strategy development while maintaining the privacy of transaction data. The system enhances transaction processing speed, reduces the network's carbon footprint, and promotes a more scalable, secure, and efficient operation of the blockchain network.

In some arrangements, one or more various steps or processes disclosed can be implemented in whole or in part as computer-executable instructions (or as computer modules or in other computer constructs) stored on computer-readable media. Functionality and steps can be performed on a machine or distributed across a plurality of machines in communication with one another.

These and other features, and features of the present technology, as well as the methods of operation and functions of the related elements of structure and the combination of parts and economies of manufacture, will become more apparent upon consideration of the following description and the added claims with reference to the drawings, all of which form a part of this specification, wherein like reference numerals designate corresponding parts in the figures. It is to be expressly understood, however, that the drawings are for illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts an exemplary, functional, architecture diagram showing sample interactions, interfaces, steps, functions, and components for a Federated-Learning-based PoW and POS system in accordance with one or more aspects of this disclosure.

FIG. 2 depicts an exemplary, functional, architecture/flow diagram showing sample interactions, interfaces, steps, functions, and components for a Federated-Learning-based PoW and PoS method in accordance with one or more aspects of this disclosure.

FIG. 3 depicts an exemplary, functional, flow diagram showing sample interactions, interfaces, steps, functions, and components for a Federated-Learning strategy to solve the block creation time in PoW systems in accordance with one or more aspects of this disclosure.

FIG. 4 depicts an exemplary, functional, flow diagram showing sample interactions, interfaces, steps, functions, and components for a Federated-Learning Strategy to solve the validation time in POS systems in accordance with one or more aspects of this disclosure.

FIGS. 5A-5B show another sample flow diagram of steps and functions that can be utilized in accordance with one or more aspects of this disclosure.

FIG. 6 shows a high-level modular view of potential system components that can be utilized in accordance with one or more aspects of this disclosure.

### DETAILED DESCRIPTION

In the following description of the various embodiments to accomplish the foregoing, reference is made to the drawings, which form a part hereof, and in which is shown by way of illustration, various embodiments in which the disclosure may be practiced. It is to be understood that other embodiments may be used, and structural and functional changes may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, many computers, machines, or the like (referenced interchangeably herein depending on context) can include one or more general-purpose, customized, configured, special-purpose, virtual, physical, and/or network-accessible devices and all hardware/software/parts therein or used therewith as understood by a skilled artisan, and may have one or more application specific integrated circuits (ASICs), microprocessors, cores, executors etc. for executing, accessing, controlling, implementing etc. various software, computer-executable instructions, data, modules, processes, routines, or the like as explained below. References herein are not considered limiting or exclusive to any type(s) of electrical device(s), or part(s), or the like, and are to be interpreted broadly as understood by people of skill in the art. Various specific or general computer/software parts, machines, or the like are not depicted to be brief, or discussed herein because they would be known and understood by ordinary artisans.

Software, computer-executable instructions, data, modules, processes, routines, or the like can be on real computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like including memory and other components thereof. Some or all the foregoing may additionally and/or alternatively be stored similarly and/or in a distributed manner in the network accessible storage/distributed data/datastores/databases/big data/blockchains/distributed ledger blockchains etc.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may use any transport that supports HTTPS or any other suitable communication, transmission, and/or other packet-based protocol.

As used herein, Generative Artificial Intelligence (AI) refers to AI techniques that learn from a representation of training data and use it to generate new content similar to or inspired by existing data. Generated content may include human-like outputs such as natural language text, source code, images/videos, and audio samples. Generative AI solutions typically leverage open-source or vendor sourced (proprietary) models, and can be provisioned in a variety of ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy. Generative artificial intelligence models have been evolving rapidly, with various organizations developing their own versions. Sample generative AI models that can be used under various parts of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models—Meta LLAMA (Language Model Meta AI): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model like GPT-3, but with further refinements and improvements. (b) AlphaFold: A specialized model for predicting protein structures, significant in biology and medicine. (5) NVIDIA AI Models—Megatron: A large, powerful transformer model designed for natural language processing tasks. (6) IBM AI Models-Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in generative AI. One or more of the foregoing may be used herein as desired. All are considered within the sphere and scope of this disclosure.

Generative AI and LLMs can be used in various parts of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing correct translations and analyses that consider the context of the situation. (7) Complex Query Handling: Utilizing chatbots and other tools to respond to intricate queries. (8) Data Management: Processing, searching, retrieving, and using large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing correct answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

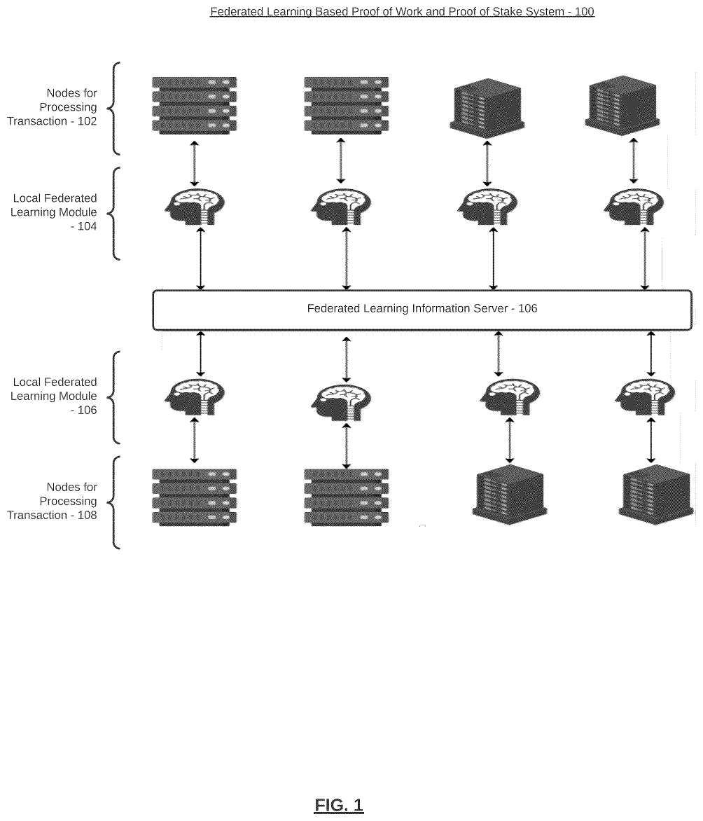

By way of non-limiting disclosure, FIG. 1 depicts an exemplary, functional, architecture diagram showing sample interactions, interfaces, steps, functions, and components for a Federated-Learning-based “Proof of Work” and “Proof of Stake” system in accordance with one or more aspects of this disclosure.

For reference, “Federated Learning” is a machine learning approach that enables the training of an algorithm across multiple decentralized devices or servers holding local data samples, without exchanging them. This technique is valuable for preserving privacy and reducing the need for data centralization and transmission.

In general, Federated Learning, as implemented herein, operates as follows:
a. Initialization: A global model is initialized and shared with all participating devices or nodes (these can be smartphones, IoT devices, or even geographically dispersed servers).
b. Local Training: Each device trains the model on its local data, creating an updated model based on its unique dataset.
c. Model Updating: After training, only the model updates (parameters or gradients) are sent back to the central server or aggregator, not the data itself.
d. Aggregation: The central server aggregates these updates to improve the global model. This aggregation can be a simple average or involve more complex algorithms to optimize learning across diverse data distributions.
e. Iteration: The improved global model is then sent back to the devices for further training. This process iterates several times, with the model incrementally learning from the entire network's data.

Federated Learning, as implemented herein, is significant for various reasons including:
a. Privacy and Security: By keeping the data localized and only sharing model updates, Federated Learning addresses privacy concerns and regulatory constraints (e.g., GDPR). It's particularly useful in sensitive sectors.
b. Bandwidth Efficiency: Reduces the need to transmit large volumes of data to a central location, saving bandwidth and reducing latency.
c. Edge Computing Compatibility: Federated Learning is well-suited for edge computing environments, where computations are performed close to where data is generated.
d. Data Diversity and Quality: It can improve model robustness by learning from a wide variety of data sources, enhancing the model's generalizability and performance on diverse datasets.

Thus, Federated Learning represents a shift towards more privacy-preserving, decentralized machine learning models, enabling AI development in a way that respects user privacy and data sovereignty. It is useful for accordance with the systems and methods disclosed.

The architecture diagram in FIG. 1 outlines a Federated Learning system applied within a blockchain environment. It shows multiple nodes responsible for processing transactions, each equipped with a Local Federated Learning Module. These modules do not track transaction data but focus on the strategies, algorithms, and resources used for block creation. The information on these strategies is calculated by the local modules and shared with a Federated Learning Information Server. This server then distributes the best strategies back to all nodes. The system incentivizes the creation and adoption of efficient block processing methods by rewarding nodes that develop the best strategies with a gas reward. This architecture supports a privacy-preserving, decentralized approach to improving blockchain efficiency and reducing resource usage.

As for the Nodes 102, each node in the network, responsible for processing transactions and creating blocks, has a Local Federated Learning Module (Local FL Module).

Local Federated Learning Modules 104 are tied to each node. They focus on optimizing strategies for block processing, including algorithm efficiency, resource utilization (CPU cores, memory), and other operational parameters, without tracking or storing transaction data.

Federated Learning Information Server (FLIS) 106 is a central server that collects strategy and resource usage information from all Local FL Modules across the network. It analyzes this data to identify the most efficient strategies.

As for strategy dissemination, once the FLIS identifies ideal strategies, it distributes this information back to the Local FL Modules 106 across all nodes 108.

Regarding strategy adoption and reward mechanisms, nodes adopt these efficient strategies to improve their block processing. The node that develops the most efficient strategy that gets widely adopted receives a gas compensation or the like as a reward, incentivizing continuous improvement and innovation.

This architecture helps with a decentralized, efficient, and privacy-preserving approach to blockchain operations, emphasizing resource optimization and strategic sharing within a Federated Learning framework.

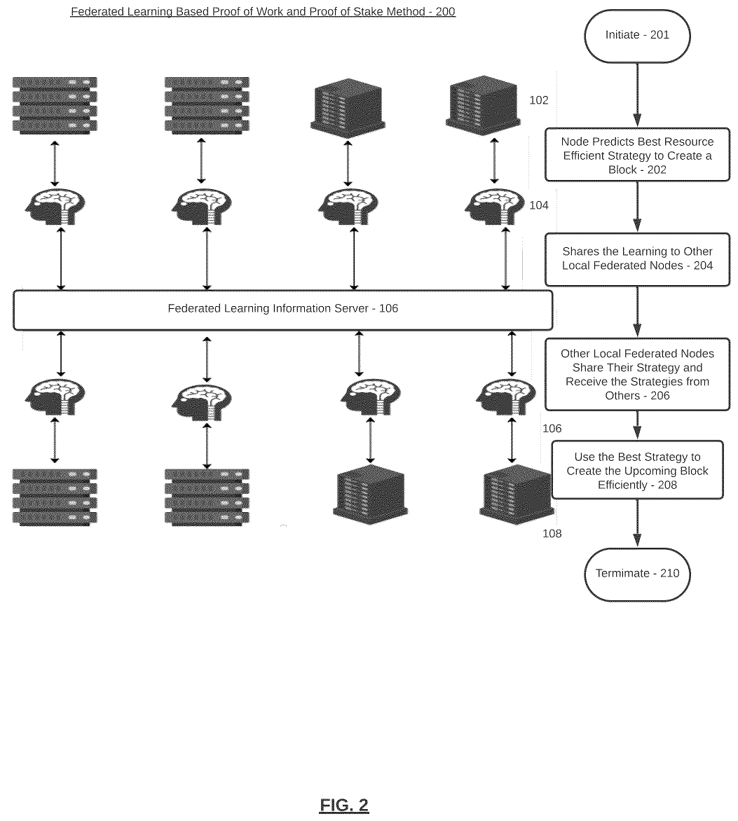

Relatedly, FIG. 2 depicts an exemplary, functional, architecture/flow diagram showing sample interactions, interfaces, steps, functions, and parts for a Federated-Learning-based PoW and PoS method under one or more parts of this disclosure and expands on the architecture illustrated in FIG. 1.

FIG. 2 shows the Federated Learning-based PoW and PoS method is operationalized within a blockchain environment. The diagram, labeled as 200, encapsulates a sophisticated workflow aimed at enhancing blockchain efficiency through Federated Learning. The following explains underlying mechanics and implications of each step in greater detail:
a. Initiate Federated Learning Information Server (FLIS) (201): The initiation phase marks the beginning of the Federated Learning process. The Federated Learning Information Server (FLIS) acts as the central hub for coordinating the learning process across the network. This server's role is pivotal, as it aggregates strategies from various nodes, analyzes them for efficiency, and redistributes the optimized strategies back to the nodes.
b. Node Predicts Best Resource-Efficient Strategy (202): Each participating node in the blockchain network applies Federated Learning algorithms to predict the most resource-efficient strategy for block creation. This involves complex computations that take into account the node's current operational parameters, such as available computational power, memory constraints, and the time required for processing transactions. The goal here is to reduce resource consumption while maintaining or enhancing the speed and reliability of block creation.
c. Shares the Learning to Other Local Federated Nodes (204): After determining a potentially efficient strategy, the node shares this information with its peers—other local federated nodes within the network. This sharing is helped with through the FLIS, making sure the knowledge dissemination process respects the network's privacy and security protocols.
d. Two-Way Strategy Exchange Among Nodes (206): In this step, a dynamic and interactive learning environment is established. Nodes engage in a two-way exchange of strategies, where each node contributes its insights and receives strategies developed by others. This collaborative effort is designed to harness collective intelligence, enabling each node to benefit from the network's cumulative knowledge and experience.
e. Selection and Application of the Optimal Strategy (208): With access to a diverse set of strategies, each node analyzes the received information to select the most effective block creation method. This choice is based on criteria such as predicted resource savings, computational efficiency, and expected impact on block processing times. Once the best strategy is identified, it is applied to the creation of upcoming blocks, thus operationalizing the benefits of Federated Learning in a real-world blockchain context.

This detailed process flow underlines the innovative application of Federated Learning principles to the domain of blockchain technology. By leveraging a decentralized approach to machine learning, the system aims to continuously evolve and adapt, optimizing resource usage across the network without compromising on privacy or security. The emphasis on strategy sharing and collective improvement encapsulates a forward-thinking model for blockchain efficiency, highlighting the potential of Federated Learning to drive sustainable and scalable growth in blockchain ecosystems.

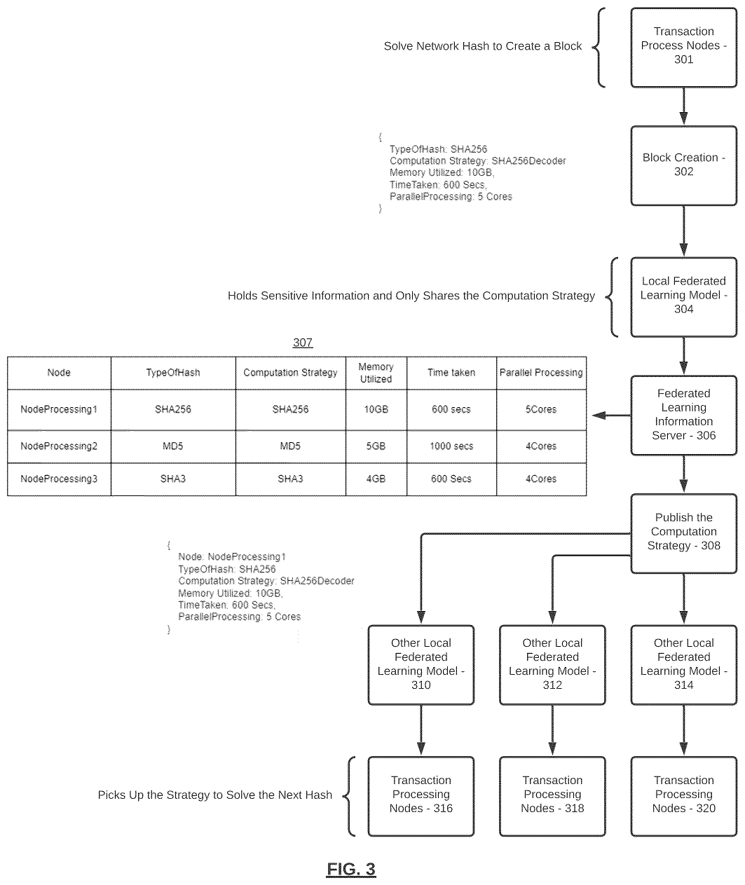

By way of non-limiting disclosure, FIG. 3 depicts an exemplary, functional, flow diagram showing sample interactions, interfaces, steps, functions, and parts for Federated Learning Strategy to Solve the Block Creation Time in PoW under one or more parts of this disclosure.

At a high level, nodes process transactions in 301 and solve network hashes, which result in blocks being created in 302. A local Federated Learning model 304 holds sensitive information and only share computational strategies. A Federated Learning information server 306 receives the output therefrom and uses it for comparative analysis as illustrated in table 307. The computation strategy is published in 308 to other local Federated Learning models 310, 312, 314, which pay their output to transaction processing nodes 316, 318, 320, which pick up the strategy to solve the next hash.

FIG. 3 outlines a detailed tabular representation of the Federated Learning Strategy to Solve the Block Creation Time in PoW. This table illustrates the comparative strategies used by different nodes (referred to in the discussion as Node Processing 1, Node Processing 2, and so forth) in their efforts to optimize block creation by using limited resources effectively.

The table shows how each node uses a distinct strategy, represented by the hash algorithm used, the amount of memory used, the time taken to create a block, and the number of cores (parallel processing capabilities) involved. For example, one node might use the SHA-256 algorithm, requiring 10 GB of memory, taking 600 seconds, and using 5 cores. Another node could use a different algorithm, such as MD5, with varying requirements for memory, time, and processing power. The table shows how each node uses a distinct strategy and yields different results.

This detailed comparison highlights the efficiency and resource utilization of each strategy, focusing on the Federated Learning model's ability to analyze and identify the most effective approach for block creation. The Federated Learning Information Server plays a critical role in this process, aggregating data on the strategies used by each node, evaluating their efficiency, and distributing the most effective strategies across the network.

The ultimate goal is to encourage nodes to adopt the most resource-efficient strategies, thus optimizing the overall network's environmental impact and operational efficiency. The node that develops and uses the most efficient strategy is rewarded with a gas reward, providing an incentive for continuous improvement and innovation within the network.

FIG. 3 illustrates a practical application of Federated Learning in a blockchain context, emphasizing the importance of strategy optimization in block creation. It shows how a decentralized network can collaboratively improve its operations while reducing its environmental footprint, aligning with the broader goals of net neutrality and sustainable computing.

As for the comparative strategies, each node is uniquely identified (e.g., Node Processing 1, Node Processing 2, etc.). Different hash algorithms (e.g., SHA-256, MD5, SHA-3) are used by nodes, affecting the computational complexity and security level of the block creation process. For memory usage, the amount of RAM or the like required for each node's strategy varies, suggesting the efficiency and scalability of the computational approach. Lower memory usage can indicate a more efficient strategy, assuming equivalent security and reliability levels. Creation time is the time taken to create a block, which is a critical factor in the network's overall throughput and efficiency. Strategies that reduce block creation time can significantly enhance the blockchain's performance. CPU Cores refers to the number of cores used directly affects the strategy's parallel processing capabilities, affecting how quickly and efficiently blocks can be created and transactions processed.

Regarding the Federated Learning Information Server (FLIS), it plays a pivotal role in aggregating strategy data from each node, analyzing this information to identify the most efficient strategies, and then distributing these optimized strategies back to the network. This iterative process ensures continuous improvement in the network's operational efficiency and environmental sustainability.

The idea of a reward mechanism is pivotal in incentivizing nodes to innovate and optimize their computational strategies. This is awarded to the node whose strategy is considered the most efficient and adopted by other nodes, akin to a transaction cost or charge in traditional payment processing networks but in digital currency and blockchain resource utilization.

As for strategic adoption and network efficiency, upon receiving the optimized strategies from the FLIS, each node evaluates and adopts the strategy that best suits its operational parameters and constraints. This collective adaptation process leads to a network-wide optimization of resource usage, reducing the environmental impact and enhancing the blockchain's overall efficiency.

This helps with the broader goals of net neutrality and environmental sustainability by emphasizing the importance of using limited resources effectively. By optimizing computational strategies for block creation, the blockchain network not only becomes more efficient but also aligns with principles of reducing energy consumption and its carbon footprint.

FIG. 3 underscores the practical application of Federated Learning within blockchain operations. It highlights how a combination of technological innovation, collaborative learning, and incentive mechanisms can drive significant improvements in efficiency, security, and sustainability.

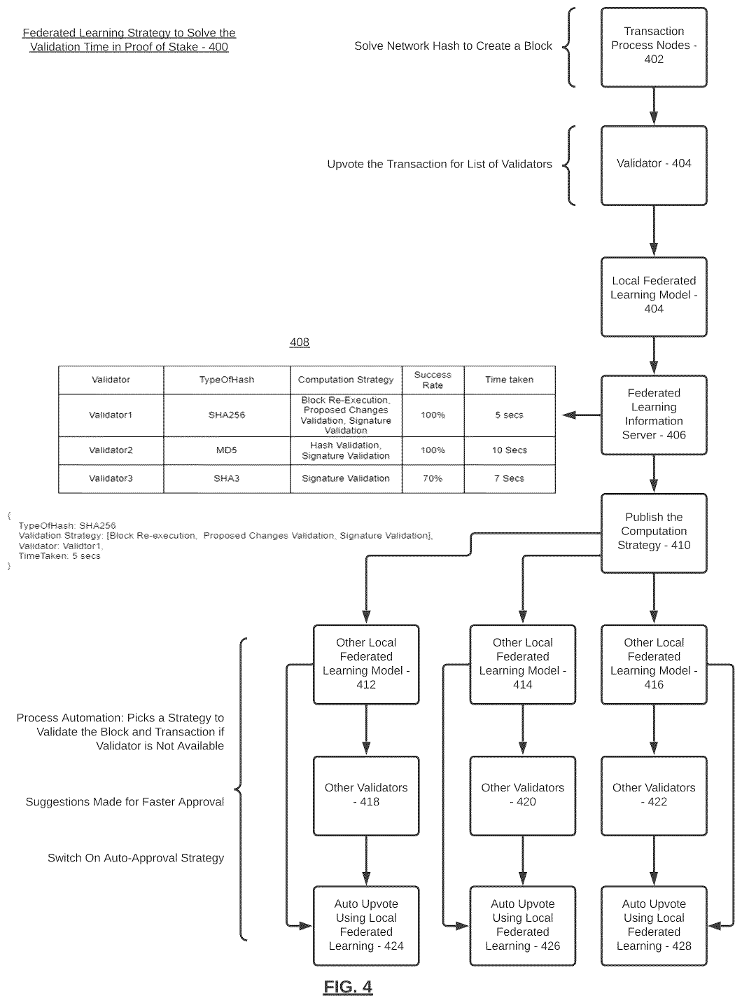

By way of non-limiting disclosure, FIG. 4 depicts an exemplary, functional, flow diagram showing sample interactions, interfaces, steps, functions, and parts for a Federated Learning Strategy to Solve the Validation Time in “Proof of Stake” under one or more parts of this disclosure.

Federated Learning Strategy to Solve the Validation Time in Proof of Stake—400 in FIG. 4 illustrates a system where Federated Learning is applied to optimize the validation process in a PoS blockchain network. This figure depicts a network of validators (e.g., Validator1, Validator2, Validator3) who are responsible for approving transactions within the blockchain. Each validator uses a unique set of computational strategies to validate transactions efficiently and accurately.

Validators (404) each use different hash algorithms (e.g., SHA-256, MD5, SHA-3) and computational strategies (e.g., block re-execution, proposed changes validation, signature validation) to confirm transactions. The effectiveness of these strategies is measured by the success rate and the time taken to approve transactions.

As illustrated, upvote the transaction for list of validators is used. This refers to a process within blockchain networks, particularly those using mechanisms like PoS or other consensus algorithms that involve validator participation. This process can be part of a broader system for achieving consensus on transactions or blocks to be added to the blockchain. In the context of blockchain validation and consensus, this can operate for example:
a. Validator Participation: In blockchain systems that use validators (such as PoS), participants (validators) are selected to propose and recommend the next block to be added to the chain. Validators are often chosen based on the amount of cryptocurrency they hold and are willing to “stake” as collateral against dishonest behavior.
b. Transaction Upvoting: The idea of “upvoting a transaction” could involve validators signaling approval for certain transactions to be included in the next block. This process is metaphorically similar to upvoting on social media platforms, where users express their support for content. In the blockchain context, validators upvote transactions they consider valid, legitimate, and suitable to include in the blockchain.

Upvoting transactions by a list of validators is an innovative approach to achieving consensus and maintaining the blockchain's integrity and efficiency. It embodies the principles of decentralized decision-making and collective intelligence, making sure the blockchain remains secure, transparent, and resilient against attacks. This method also highlights the evolution of blockchain technology towards more participatory and adaptive consensus mechanisms, leveraging the strengths of its community of validators.

The computation strategy can include various methods such as block re-execution, which involves verifying the originality of transactions within a block; proposed changes validation, which assesses any amendments within the transaction data; and signature validation, which confirms the authenticity of the transaction signatures.

A success rate indicates the percentage of transactions successfully validated by each validator using their chosen strategies. A higher success rate signifies a more effective validation process.

Time taken refers to the duration required to validate transactions. Efficiency in the POS system is partly measured by the ability to reduce validation time, with faster validations being more desirable.

Process Automation allows for automating the validation process when a validator is unavailable, using predefined strategies to ensure continuous operation. Suggestions can be made for faster approval as indicated. This illustrates the collaborative part of Federated Learning, where validators share insights and strategies for improving transaction validation times. Auto upvote using local Federated Learning shows an advanced feature where validators can automatically endorse strategies that have proven to be efficient, further streamlining the validation process.

The system relies on a centralized Federated Learning Information Server (FLIS) to aggregate, analyze, and distribute the most effective computational strategies across the network. However, a more decentralized, peer-to-peer (P2P) model could be used. In this model, validators can directly share and receive strategies with each other, potentially transitioning from a supervised to an unsupervised learning framework. This peer-to-peer arrangement enhances the network's resilience and flexibility, allowing for a more dynamic and self-sufficient approach to strategy optimization.

In PoS, the emphasis is not on solving complex cryptographic puzzles, as in PoW, but rather on the choice of validators based on their stake in the network and the efficiency of their validation strategies. FIG. 4 underscores the importance of strategic efficiency in transaction validation, rewarding validators who contribute to faster, more reliable validation processes. By incorporating Federated Learning into POS, the network can significantly improve its operational efficiency, security, and overall resource utilization, aligning with broader goals of sustainability and scalability in blockchain technologies.

Incorporating Federated Learning into POS transforms how validators are selected and how transaction validations are performed. By prioritizing efficiency and strategic innovation, this approach aligns with the core principles of PoS, where the validators' stake and their contribution to the network's security and efficiency determine their influence. This model not only enhances transaction throughput and reduces validation times but also strengthens the network's security by making sure only the most reliable and effective strategies are employed.

Thus, FIG. 4, and the rest of this disclosure, illustrates a sophisticated framework designed to optimize blockchain operations through collaborative intelligence and strategic innovation. This model represents a forward-thinking approach to blockchain management, emphasizing efficiency, security, and adaptability. By rewarding validators for contributing high-performance strategies and enabling a transition to a decentralized learning model, Federated Learning offers a pathway to more sustainable and scalable blockchain ecosystems.

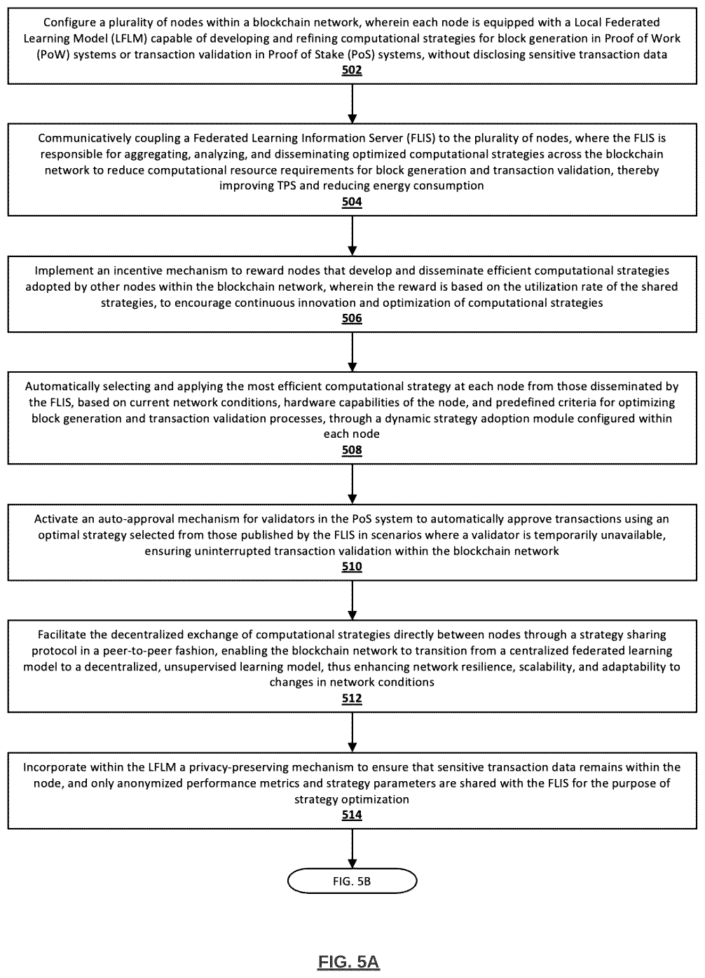

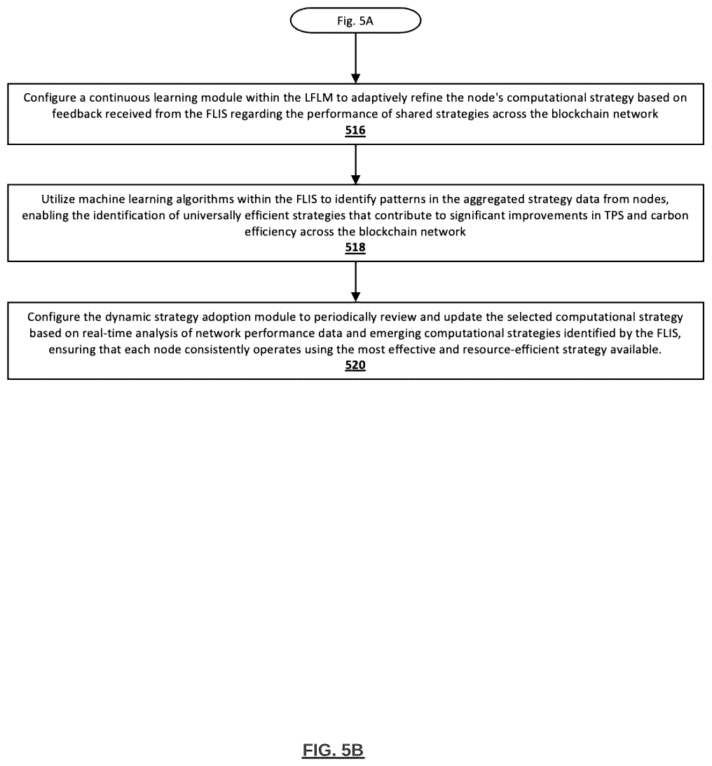

By way of non-limiting reference, FIGS. 5A-5B show another sample flow diagram of steps and functions that can be used under one or more parts of this disclosure.

In FIG. 5A, the flow diagram illustrates a detailed method for optimizing transaction processing speed (TPS) and enhancing carbon efficiency in a blockchain network using Federated Learning:
a. Configure Nodes (502): The process starts with configuring a plurality of nodes within a blockchain network. Each node has a Local Federated Learning Model (LFLM) capable of developing and refining computational strategies for block generation in PoW systems or transaction validation in POS systems without revealing sensitive transaction data.
b. Communicative Coupling with FLIS (504): A Federated Learning Information Server (FLIS) is communicatively coupled to the nodes. The FLIS is responsible for aggregating, analyzing, and distributing optimized computational strategies across the blockchain network. This is done to reduce the computational resources required for block generation and transaction validation, thus improving TPS and reducing energy consumption.
c. Incentive Mechanism (506): An incentive mechanism is implemented to reward nodes that develop and distribute efficient computational strategies adopted by other nodes within the blockchain network. The rewards are based on the utilization rate of the shared strategies, encouraging continuous innovation and optimization of computational strategies.
d. Dynamic Strategy Adoption (508): Each node automatically selects and applies the most efficient computational strategy from those distributed by the FLIS. This choice is based on current network conditions, hardware capabilities of the node, and predefined criteria for optimizing block generation and transaction validation processes.
e. Auto-approval Mechanism (510): An auto-approval mechanism for validators in the POS system is activated. This mechanism automatically approves transactions using an ideal strategy selected from those published by the FLIS in scenarios where a validator is temporarily unavailable, ensuring uninterrupted transaction validation within the blockchain network.
f. Decentralized Strategy Exchange (512): The method helps with the decentralized exchange of computational strategies directly between nodes. This is achieved through a strategy sharing protocol in a peer-to-peer fashion, enabling the network to transition from a centralized Federated Learning model to a decentralized, unsupervised learning model, thus enhancing network resilience, scalability, and adaptability to changes in network conditions.

In FIG. 5B, more steps are detailed:
a. Continuous Learning Module (516): A continuous learning module within the LFLM is configured to adaptively refine the node's computational strategy. This refinement is based on feedback received from the FLIS regarding the performance of shared strategies across the blockchain network.
b. Use Machine Learning (518): Machine learning algorithms are used within the FLIS to identify patterns in the aggregated strategy data from nodes. This enables the identification of universally efficient strategies that contribute to significant improvements in TPS and carbon efficiency across the blockchain network.
c. Dynamic Strategy Review (520): The dynamic strategy adoption module is configured to periodically review and update the selected computational strategy. This is based on real-time analysis of network performance data and emerging computational strategies identified by the FLIS, making sure each node consistently runs using the most effective and resource-efficient strategy available.

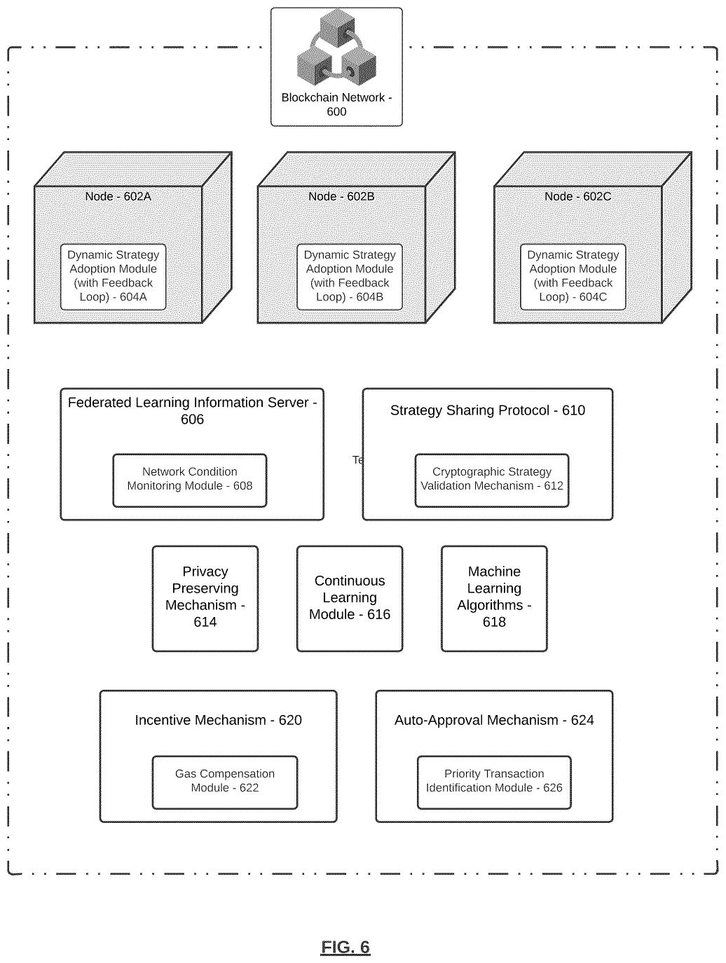

By way of non-limiting reference, FIG. 6 shows a high-level modular view of potential system parts that can be used under one or more parts of this disclosure. As an overview, a system is shown for enhancing blockchain efficiency through Federated Learning, incorporating nodes with Local Federated Learning Models (LFLMs) for optimizing block generation and validation strategies without exposing sensitive data. The Federated Learning Information Server (FLIS) aggregates and distributes these strategies, aiming to reduce computational resource needs and improve transaction speeds. Nodes are incentivized to develop and share effective strategies, with a dynamic adoption module for strategy application based on network conditions. The system includes a privacy-preserving mechanism, continuous learning based on FLIS feedback, and an auto-approval mechanism for transactions, enhancing network resilience and scalability. Machine learning identifies efficient strategies, supported by a gas compensation model for rewarding contributions, and a tiered reward structure promotes innovative strategy development.

The system enhances blockchain networks' transaction processing speed and carbon efficiency using Federated Learning. It consists of nodes with Local Federated Learning Models (LFLMs) for developing computational strategies, a Federated Learning Information Server (FLIS) for strategy aggregation and dissemination, and an incentive mechanism rewarding efficient strategy development. The system includes modules for dynamic strategy adoption, auto-approval of transactions, and privacy preservation. Machine learning algorithms identify efficient strategies, while an optimization feedback loop refines future strategy selection. Features include priority transaction identification, cryptographic strategy validation, network condition monitoring, and a tiered reward structure, promoting innovation and sustainability.

In specific reference to the elements of FIG. 6, the exemplary architecture of a blockchain network system designed to optimize transaction processing speed (TPS) and enhance carbon efficiency through Federated Learning is delineated. The figure illustrates a blockchain network (600) comprising multiple nodes (602A, 602B, 602C) each equipped with a Dynamic Strategy Adoption Module (604A, 604B, 604C) featuring a feedback loop for continuous strategy refinement. Central to this architecture is the Federated Learning Information Server (FLIS) (606), responsible for aggregating, analyzing, and distributing computational strategies across the network. The system integrates a Network Condition Monitoring Module (608) for assessing blockchain performance in real-time and adjusting strategies.

A Strategy Sharing Protocol (610) enables decentralized, peer-to-peer exchange of computational strategies, fostering a collaborative learning environment. The Cryptographic Strategy Validation Mechanism (612) ensures the integrity and security of shared strategies. Privacy is safeguarded through a Privacy Preserving Mechanism (614), which lets nodes participate without revealing sensitive transaction data. Continuous learning and adaptation are facilitated by a Continuous Learning Module (616) and incorporating Machine Learning Algorithms (618) within the FLIS to identify and promote the most effective strategies.

The Incentive Mechanism (620), augmented (if desired) by a Gas Compensation Module (622), motivates nodes to develop and share innovative strategies by providing rewards based on strategy adoption and effectiveness. An Auto-Approval Mechanism (624) ensures uninterrupted transaction validation, especially in PoS systems, by automatically approving transactions using ideal strategies. The Priority Transaction Identification Module (626) enhances the system's responsiveness to time-sensitive transactions, prioritizing them based on predefined criteria.

Although the present technology has been described for illustration based on what is currently considered the most practical and preferred implementations, it is to be understood that this detail is only for that purpose and that the technology is not limited to the disclosed implementations, but, on the contrary, is intended to cover changes and equivalent arrangements that are within the spirit and scope of the appended claims. For example, it is to be understood that the present technology contemplates that, to the extent possible, one or more features of any implementation can be combined with one or more features of any other implementation.

1. A system for optimizing transaction processing speed (TPS) and enhancing carbon efficiency in blockchain networks through Federated Learning, the system comprising:
a plurality of nodes configured to participate in a blockchain network, wherein each node is equipped with a Local Federated Learning Model (LFLM) that is configured to develop and refine computational strategies for block generation in a Proof of Work (PoW) system or transaction validation in a Proof of Stake (POS) system without disclosing sensitive data;
a Federated Learning Information Server (FLIS) communicatively coupled to the plurality of nodes, wherein the FLIS is configured to aggregate, analyze, and disseminate optimized computational strategies across the blockchain network, wherein the strategies are aimed at reducing computational resources required for block generation and transaction validation, thereby improving TPS and reducing energy consumption associated with blockchain network operations;
an incentive mechanism configured to reward nodes that develop and share efficient computational strategies that are adopted by other nodes within the blockchain network, wherein the reward is based on utilization of shared strategies by other nodes, thereby encouraging continuous innovation and optimization of computational strategies within the blockchain network;
a dynamic strategy adoption module configured within each node to automatically select and apply the most efficient computational strategy shared by the FLIS based on current network conditions, hardware capabilities of the node, and predefined criteria for optimizing block generation and transaction validation processes;
an auto-approval mechanism for validators in the POS system, wherein the mechanism is configured to automatically approve transactions using an optimal strategy selected from the strategies published by the FLIS in scenarios where a validator is temporarily unavailable, ensuring uninterrupted transaction validation within the blockchain network; and
a strategy sharing protocol that facilitates decentralized exchange of computational strategies directly between nodes in a peer-to-peer fashion, enabling the blockchain network to transition from a centralized Federated Learning model to a decentralized, unsupervised learning model, thereby enhancing network resilience, scalability, and adaptability to changes in network conditions.

2. The system of claim 1, wherein the LFLM further comprises:
a privacy-preserving mechanism that ensures sensitive transaction data remains within the node and only anonymized performance metrics and strategy parameters are shared with the FLIS for strategy optimization; and
a continuous learning module configured to adaptively refine the node's computational strategy based on feedback received from the FLIS regarding the performance of shared strategies across the blockchain network.

3. The system of claim 2, wherein the FLIS utilizes machine learning algorithms to identify patterns in aggregated strategy data from nodes, enabling the identification of universally efficient strategies that contribute to significant improvements in TPS and carbon efficiency across the blockchain network.

4. The system of claim 3, wherein the incentive mechanism further comprises a gas compensation model that allocates rewards of cryptocurrency or transaction amount discounts to nodes contributing strategies that lead to measurable improvements in network performance and environmental sustainability.

5. The system of claim 4, wherein the dynamic strategy adoption module is further configured to periodically review and update a selected computational strategy based on real-time analysis of network performance data and emerging computational strategies identified by the FLIS, ensuring that each node consistently operates using the most effective and resource-efficient strategy available.

6. The system of claim 5, further comprising: an optimization feedback loop within the dynamic strategy adoption module, configured to automatically report performance outcomes of the adopted computational strategies back to the LFLM, wherein the feedback loop enhances precision of future strategy selections by incorporating real-world performance data into the LFLM's strategy refinement process.

7. The system of claim 6, wherein the auto-approval mechanism for validators is further enhanced by: a priority transaction identification feature, configured to recognize high-priority transactions based on predefined criteria and ensure their expedited validation by applying the most efficient computational strategy available, thereby optimizing the blockchain network's responsiveness to time-sensitive transactions.

8. The system of claim 7, wherein the strategy sharing protocol includes: a cryptographic strategy validation mechanism, configured to authenticate origin and integrity of shared computational strategies, ensuring that only verified and secure strategies are disseminated and adopted across the blockchain network, thereby maintaining network security posture while facilitating decentralized learning.

9. The system of claim 8, further comprising: a network condition monitoring module within the FLIS, configured to continuously assess a current state of the blockchain network, including transaction volume, block generation time, and overall network congestion, and dynamically adjust the dissemination of computational strategies to prioritize those most effective under prevailing network conditions.

10. The system of claim 9, wherein the incentive mechanism is further configured to: implement a tiered reward structure that variably compensates nodes based on an impact level of their contributed computational strategies on the blockchain network's efficiency and carbon footprint, thereby incentivizing the development and sharing of groundbreaking strategies that offer the highest benefits in terms of TPS improvement and energy consumption reduction.

11. A method for optimizing transaction processing speed (TPS) and enhancing carbon efficiency in blockchain networks through Federated Learning, the method comprising the steps of:
configuring a plurality of nodes within a blockchain network, wherein each node is equipped with a Local Federated Learning Model (LFLM) capable of developing and refining computational strategies for block generation in Proof of Work (PoW) systems or transaction validation in Proof of Stake (POS) systems, without disclosing sensitive transaction data;
communicatively coupling a Federated Learning Information Server (FLIS) to the plurality of nodes, where the FLIS is responsible for aggregating, analyzing, and disseminating optimized computational strategies across the blockchain network to reduce computational resource requirements for block generation and transaction validation, thereby improving TPS and reducing energy consumption;
implementing an incentive mechanism to reward nodes that develop and disseminate efficient computational strategies adopted by other nodes within the blockchain network, wherein the reward is based on utilization rate of shared strategies, to encourage continuous innovation and optimization of computational strategies;
automatically selecting and applying the most efficient computational strategy at each node from those disseminated by the FLIS, based on current network conditions, hardware capabilities of the node, and predefined criteria for optimizing block generation and transaction validation processes, through a dynamic strategy adoption module configured within each node;
activating an auto-approval mechanism for validators in the POS system to automatically approve transactions using an optimal strategy selected from those published by the FLIS in scenarios where a validator is temporarily unavailable, ensuring uninterrupted transaction validation within the blockchain network;
facilitating the decentralized exchange of computational strategies directly between nodes through a strategy sharing protocol in a peer-to-peer fashion, enabling the blockchain network to transition from a centralized Federated Learning model to a decentralized, unsupervised learning model, thus enhancing network resilience, scalability, and adaptability to changes in network conditions;
incorporating within the LFLM a privacy-preserving mechanism to ensure that sensitive transaction data remains within the node, and only anonymized performance metrics and strategy parameters are shared with the FLIS for the purpose of strategy optimization;
configuring a continuous learning module within the LFLM to adaptively refine the node's computational strategy based on feedback received from the FLIS regarding the performance of shared strategies across the blockchain network;
utilizing machine learning algorithms within the FLIS to identify patterns in the aggregated strategy data from nodes, enabling the identification of universally efficient strategies that contribute to significant improvements in TPS and carbon efficiency across the blockchain network;
comprising within the incentive mechanism a gas compensation model that allocates rewards in the form of cryptocurrency or transaction amount discounts to nodes contributing strategies that lead to measurable improvements in network performance and environmental sustainability; and
configuring the dynamic strategy adoption module to periodically review and update the selected computational strategy based on real-time analysis of network performance data and emerging computational strategies identified by the FLIS, ensuring that each node consistently operates using the most effective and resource-efficient strategy available.

12. The method of claim 11, further comprising the step of: analyzing real-time performance outcomes of the adopted computational strategies at each node, and automatically reporting these outcomes back to the LFLM as part of an optimization feedback loop, wherein the feedback loop is configured to enhance the precision of future strategy selections by incorporating real-world performance data into a strategy refinement process.

13. The method of claim 12, further comprising the step of: recognizing high-priority transactions through a priority transaction identification feature within the auto-approval mechanism, configured to expedite the validation of these transactions by applying the most efficient computational strategy available, optimizing the blockchain network's responsiveness to time-sensitive transactions.

14. The method of claim 13, further comprising the step of: authenticating the origin and integrity of shared computational strategies using a cryptographic strategy validation mechanism within the strategy sharing protocol, ensuring that only verified and secure strategies are disseminated and adopted across the blockchain network, thereby maintaining the network's security posture.

15. The method of claim 14, further comprising the step of: continuously assessing the current state of the blockchain network, including transaction volume, block generation time, and overall network congestion, through a network condition monitoring module within the FLIS, and dynamically adjusting the dissemination of computational strategies to prioritize those most effective under the prevailing network conditions.

16. The method of claim 15, further comprising the step of: implementing a tiered reward structure within the incentive mechanism, designed to variably compensate nodes based on the impact level of their contributed computational strategies on the blockchain network's efficiency and carbon footprint, incentivizing the development and sharing of groundbreaking strategies that offer the highest benefits in terms of TPS improvement and energy consumption reduction.

17. The method of claim 16, further comprising the step of: establishing a decentralized strategy update mechanism that allows nodes to directly exchange updates on computational strategies without relying on the FLIS, enhancing network ability to rapidly adapt to changes and innovations in computational strategies and further decentralizing a learning process.

18. The method of claim 17, further comprising the step of: integrating an adaptive learning rate adjustment feature within the LFLM, configured to modify the learning rate based on complexity of the computational strategy and node performance history, optimizing the speed and effectiveness of strategy refinement and adoption processes.

19. The method of claim 18, further comprising the step of: deploying a collaborative anomaly detection module across the network, wherein nodes work together to identify and mitigate potential security threats or inefficiencies in computational strategies, leveraging collective intelligence of the blockchain network to enhance security and efficiency through Federated Learning.

20. A blockchain network optimization system comprising:
a network of blockchain nodes, each node configured with a local learning module for independently developing computational strategies aimed at optimizing block generation and transaction validation processes;
a centralized analysis and distribution server configured to aggregate computational strategies developed by the nodes, analyze effectiveness of these strategies in terms of transaction processing speed and resource efficiency, and disseminate optimized strategies back to the network;
an incentive mechanism configured to reward nodes for creation and sharing of strategies that result in measurable improvements in network performance and environmental sustainability, with rewards based on adoption rate and effectiveness of the shared strategies;
a dynamic adaptation mechanism within each node, configured to automatically select and implement the most efficient computational strategy available from the centralized server based on real-time network conditions, hardware capabilities, and environmental impact considerations;
an automated validation mechanism for transaction validators in systems utilizing a Proof of Stake consensus model, enabling automatic transaction approval in the absence of validators, based on preselected optimal strategies to ensure continuous network operation; and
a strategy sharing framework enabling exchange of computational strategies among nodes, facilitating a decentralized and collaborative approach to continuous network optimization;
wherein the system utilizes Federated Learning principles to enable collective intelligence in strategy development without compromising privacy of transaction data, thereby enhancing transaction processing speed, reducing a carbon footprint of the network, and promoting a more scalable, secure, and efficient blockchain network operation.
